(19) United States
(12) Patent Application Publication
(10) Pub. No.: US 2011/0197559 A1
(43) Pub. Date: Aug. 18, 2011

(54) GRASS COLLECTION CONTAINER FOR LAWN MOWER

(75) Inventor: Marcus Gordon BIRCH, London (CA)

(73) Assignee: Marcus Gordon Birch, London (CA)

(21) Appl. No.: 13/029,647

(22) Filed: Feb. 17, 2011

Related U.S. Application Data
(60) Provisional application No. 61/305,224, filed on Feb. 17, 2010.

(51) Int. Cl. A01D 43/06; A01D 34/00

(52) U.S. Cl. 56/17.1; 56/202

(57) ABSTRACT

The present invention relates to a grass-collection container for attachment to a lawn mower, wherein said grass-collection container comprises: (a) an open mounting portion, said open mounting portion configured to interface with a grass clipping discharge chute of the lawn mower, and to allow transport therethrough of the grass clippings discharged by the chute; and (b) a bag portion for receiving the grass clippings, said bag portion including discharging means configured to permit discharge of the grass clippings from the bag portion while the grass is being cut by said lawn mower. The present invention also relates to a lawn mower comprising the grass-collection container of the invention and to a new method of mowing grass using the grass-collection container of the invention.

### CROSS REFERENCE TO RELATED APPLICATIONS

This application claims the benefit of the filing date of U.S. Provisional Application No. 61/305,224, filed Feb. 17, 2010 by the present inventor, the content of which is specifically incorporated herein by reference.

### FIELD OF THE INVENTION

The present invention relates to a grass-collection container adapted for attachment to a lawn mower for the purpose of collecting grass clippings from the mower to the grass-collection container. More specifically, the present invention relates to a grass-collection container having a bottom opening for releasing to the turf the grass clippings collected from the lawn mower.

### BACKGROUND OF THE INVENTION

Lawn mowers can be configured into three lawn cutting configurations, specifically: (1) a bagging configuration that collects the grass cut by the cutting blade in a grass container such as a hopper or bag; (2) a side-discharge configuration that discharges the cut grass through an opening in the side of the mower deck in order to leave the grass clippings on the lawn; and (3) a mulching configuration that chops the grass clippings more finely within the cutting chamber formed by the mower deck and discharge the clippings downward of the deck.

Each of the three configurations has its advantages and disadvantages.

Mulching mowers are designed to cut grass into very small pieces that decompose more quickly than grass cut by conventional mowers. The mower blades are designed to create a mild vacuum in the mower deck until the grass is cut into small pieces. In the mulching configuration clippings are returned to the turf where they will be decomposed very rapidly. This reduces yard waste and recycles nutrients to the turf. Mulching prevents yard waste from contributing to landfill overuse and eliminates clipping collection and disposal costs. However, mulching is ineffective on wet or tall turf, blades must be kept sharp and the lawn mower requires higher horsepower.

In the side-discharge configuration, the mower distributes longer clippings across the surface of the lawn and avoids bagging. However, the discharged clippings sit on top of the turf, dry out in the sun and generally look bad. In addition, the clippings are discharged from the lawn mower through a side chute with considerable force and speed and the clippings usually end up on the surface of a deck or patio or in the neighbour's property. Furthermore, the discharged clippings could hurt a person at a distance.

The bagging configuration produces, arguably, the best lawn cut. The lawn remains clean, the life of the blades of the lawn mower is increased and there is little chance of injuries. However, bagging requires the user to discharge the bag frequently. This operation includes detaching the bag from the lawn mower, carrying the bag filled with clippings to a container or the like to empty the bag and reattaching the bag to the lawn mower.

US Pat. Appl. No. 20020166315 (US '315) discloses a lawn mower bag grass catcher having a side opening with a zipper for the discharge of grass. However, in order to release the grass clippings from the bag grass catcher of US '315, the bag needs to be detached from the lawn mower, or the user needs to use his/her hands to take the grass clippings out, or the lawn mower needs to be tilted to the side of the opening. Furthermore, the bag grass catcher of US '315 does not permit for the release of grass clippings from the bag grass catcher.

The applicant has invented a new and inventive grass-collection container that allows for a new lawn cutting configuration which overcomes the disadvantages of the three configurations described above, while keeping most, if not all, of their advantages.

### SUMMARY OF THE INVENTION

In one aspect, the present invention provides for a grass-collection container for attachment to a lawn mower, wherein said grass-collection container comprises: (a) an open mounting portion, said open mounting portion configured to interface with a grass clipping discharge chute of the lawn mower, and to allow transport therethrough of the grass clippings discharged by the chute; and (b) a bag portion for receiving the grass clippings, said bag portion including discharging means configured to permit discharge of the grass clippings from the bag portion while the grass is being cut by said lawn mower.

In another aspect, the present invention provides for a lawn mower capable of being configured to selectively bag grass clippings, wherein the lawn mower comprises: (1) a mower base configured to cut grass, said mower base having a grass clippings discharge chute through which grass clippings can exit the mower base; and (2) a grass-collection container attached to said base, said grass-collection container comprising: (a) an open mounting portion, said open mounting portion configured to interface with the grass clippings discharge chute and to allow transport therethrough of the grass clippings discharged by the chute; and (b) a bag portion for receiving the grass clippings, wherein said bag portion includes discharging means configured to permit discharge of the grass clippings from the bag portion while the grass is being mowed by said lawn mower.

In another aspect, the present invention provides for a method of mowing grass, wherein said method comprises: (1) providing a lawn mower capable of being configured to selectively bag grass clippings into a grass-collection container, the grass-collection container comprising: (a) an open mounting portion configured to interface with a grass clippings discharge chute of the mower and to allow transport therethrough of the grass clippings discharged by the chute; and (b) a bag portion for receiving the grass clippings cut by said lawn mower, said bag portion including discharging means configured to permit discharge of the grass clippings from the bag portion while the grass in being cut; and (2) operating the lawn mower for cutting the grass, thereby discharging the grass clippings through the discharging means while the grass is being cut by said lawn mower.

In aspects of the invention the discharging means comprise one or more discharging openings. In aspects of the invention the one or more discharging openings have a polygonal shape or a circular shape.

In aspects of the invention the discharging means is located on a bottom side of the bag portion such that the discharging means is facing the ground when the grass-collection container is attached to said lawn mower.

In aspects of the invention the discharging means is configured to be selectively opened or closed.

In aspects of the invention the bag portion includes one or more flaps for selectively closing or opening the discharging means.

In aspects of the invention the one or more flap means are adapted to protect a lawn mower operator from the grass clippings being discharged through the discharging means while the grass is being cut by said lawn mower.

In aspects of the invention the grass-collection container is configured to be removably attached to the lawn mower.

The novel grass-collection container and methods of the present invention may provide at least the following advantages:
a. Clean cut of the lawn as in the bagging configuration with the added advantage that the clippings are returned to the turf where they will be decomposed very rapidly.
b. No clipping collection and disposal costs.
c. Effective on wet or tall turf and the lawn mower does not require higher horsepower.
d. Clippings are evenly disposed on the ground in front of the user.
e. No danger of injuries caused by flying debris.
f. Avoidance of throwing clippings to neighbour's property, decks or patios.
g. No need to remove the grass-collection container from the lawn mower to empty the grass.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a side view of a lawn mower according to one embodiment of the present invention; and

FIG. 2 is a perspective view from the bottom side of the grass-collection container according to one embodiment of the present invention showing the discharge hole in the closed position.

FIG. 3 is a perspective view from the bottom side of the grass-collection container according to one embodiment of the present invention showing the discharge hole in the open position.

FIG. 4 is a side view of the grass-collection container of the present invention attached to a lawn mower in accordance to one embodiment of the present invention.

FIG. 5 is a side view of the grass-collection container of the present invention attached to a lawn mower illustrating the lawn mower and grass-collection container in operation in accordance to one embodiment of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE INVENTION

Unless defined otherwise, all technical and scientific terms used herein have the same meaning as commonly understood by one of ordinary skill in the art to which this invention belongs. Also, unless indicated otherwise, except within the claims, the use of “or” includes “and” and vice-versa. Non-limiting terms are not to be construed as limiting unless expressly stated or the context clearly indicates otherwise (for example “including”, “having” and “comprising” typically indicate “including without limitation”). Singular forms including in the claims such as “a”, “an” and “the” include the plural reference unless expressly stated otherwise. All publications cited in this document are incorporated herein by reference.

The invention will be explained in details by referring to the figures.

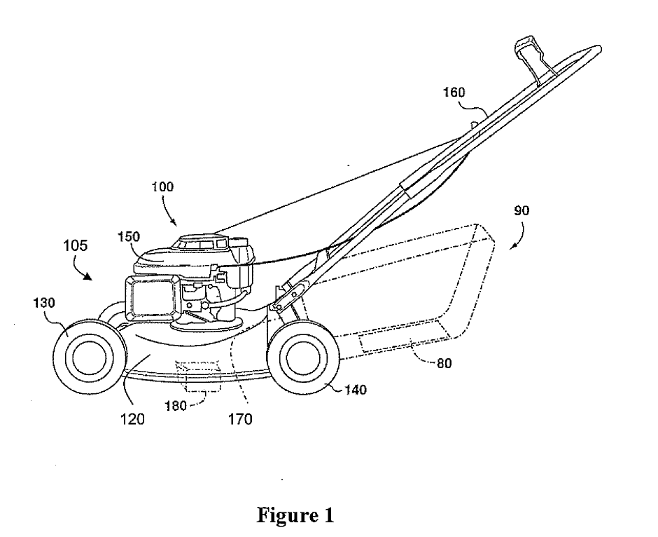

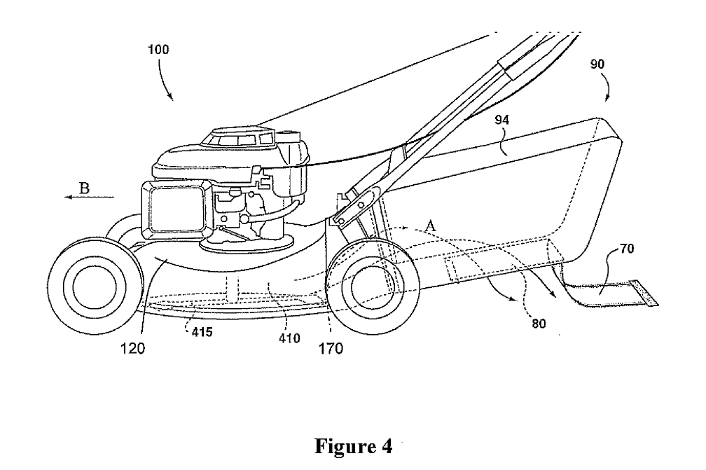

Referring to FIG. 1, a typical lawn mower 100 is illustrated. The lawn mower 100 may include a base 105 and handles 160. The base 105 may include a body 120 and a power source 150. The body 120 may be provided with two wheels 130 at the front and two at the rear 140. Mounted on the upper side of the body 120 may be power source 150 such as an engine, for driving the rotating cutting blade. The power source 150 may also drive the rear wheels 140, although the front wheels 130 may also be driven by the power source 150. Attached to the upper rear end of the body 120 may be front ends of a handle 160 extending diagonally upwardly. An opening or chute 170 for discharging the grass clippings from the body 120 may be provided on the rear end face of the body 120. The lawn mower 100 may also be provided with an outlet 180 on a side of the body 120 for discharging grass from the side of body 120. As illustrated in FIG. 4, disposed on the lower side of the body 120 may be a cutting chamber 410 housing the rotating cutting blade 415 driven by the power source.

In one embodiment, the present invention provides for a grass-collection container for attachment to a lawn mower. The grass-collection container of the present invention may comprise: (a) an open mounting portion, said open mounting portion may be configured to interface with a grass clipping discharge chute of the lawn mower, and to allow transport therethrough of the grass discharged by the chute; and (b) a bag portion which may be configured for receiving the grass clippings, said bag portion may include discharging means configured to permit discharge of the grass clippings from the bag portion while the grass is being cut by said lawn mower.

FIGS. 1 to 5 illustrate a grass-collection container or receptacle 90 according to one preferred embodiment of the present invention. The grass-collection container 90 may comprise a bag portion 91 and an open mounting portion 92.

The open mounting portion 92 may be configured to interface with the grass clippings discharge chute 170 of the lawn mower 100 and to transport therethrough (i.e. through the open mounting portion) the grass clippings 510 which may be cut by the lawn mower 100. In one aspect of the present invention, the open mounting portion of the grass-collection container may be configured to interface with the outlet on a side of the body of the lawn mower.

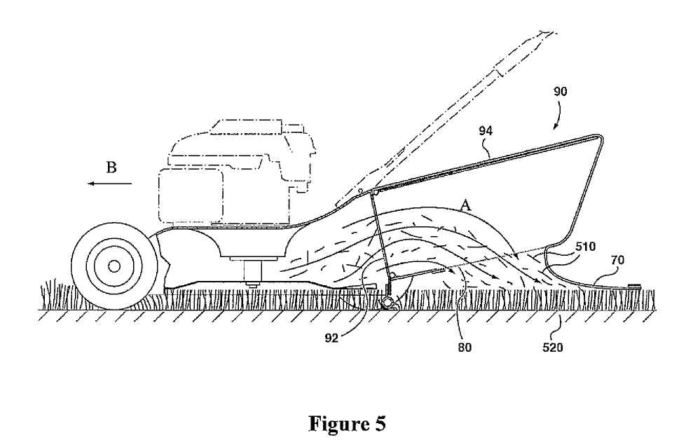

As illustrated in FIGS. 4 and 5, the bag portion 91 may be configured for receiving grass clippings 510 transported through the chute 170. The bag portion includes discharging means 80 which may be configured to permit the exit or discharge of the grass clippings 515 from (out of) the bag portion 91 while the grass is being mowed by said lawn mower.

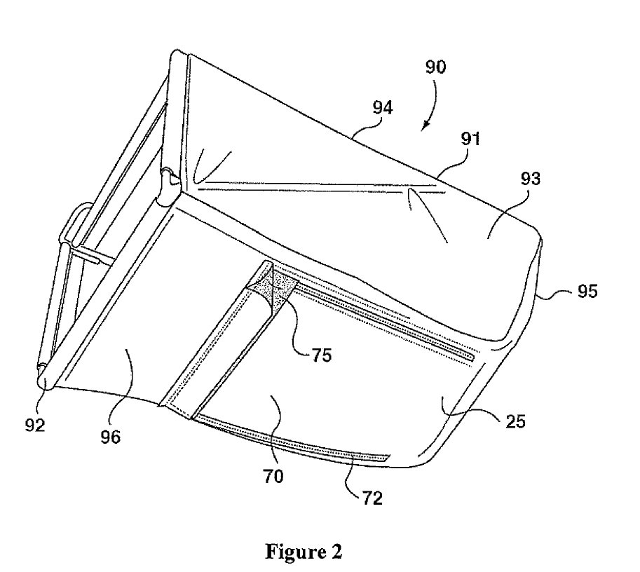

As illustrated in FIGS. 2 to 5, the bag portion 91 may include a bag bottom 96, two lateral sides 93 extending from the bag bottom 96, a bag top 94, and a bag rear 95 opposite to the mounting portion 92. The bag bottom 96 may be facing the ground 520 when the grass-collection container 90 is attached to the lawn mower 100. It would be obvious to person of ordinary skill in the art that other bag portion designs may be used with the present invention with the proviso that the design does not interfere with the grass clippings being released through the discharging means while the grass is being cut. The discharging means 80 may be located on the bag bottom 96, such that the discharging means 80 would be facing the ground when the grass-collection container 90 is attached to the lawn mower 100. The discharging means may take any suitable form or shape that would permit the exit or discharge of the grass clippings from the bag portion. For example, the discharging may take the form of a discharging hole or opening as illustrated in the figures. The grass clippings 510 may be discharged through the discharging hole 80 in the direction defined by the arrows A of FIGS. 4 and 5, while the grass is being cut. The grass clippings 510 discharged through the discharging hole 80 may thereby be returned to the turf 520 in front of the lawn mower operator or user. Although the figures illustrate one discharging hole, it would be obvious to person of ordinary skill in the art that one more discharging openings may be included in the bag.

In one embodiment, a plastic chute (not shown) may extend from the discharge chute of the lawn mower into the bag portion to facilitate the exit or discharge of the grass clippings through the discharging means.

The grass collection container of the present invention may be removably attached to the body of the lawn mower via the open mounting portion of the grass collection container, which is configured to interface with the discharging chute of the lawn mower. The bag portion may collect grass clippings which have been cut by the rotating cutting blade and carried therein by a flow of air through the chute and the open mounting portion.

The grass-collection container of the present invention may be constructed of any suitable durable, rugged nylon or some other suitable material for containing vegetation clippings and handling the rugged environment of lawn and garden care. The bag portion of the grass-collection container of present invention may be made of a porous material having air openings through which the carrying flow of air can pass but grass cuttings cannot pass. The bottom wall of the bag portion may be relatively rigid or stiff to give the grass-collection container structure and ensure that the discharging means is/are open during lawn mower use. For example, the bottom wall may be made of any suitable rigid plastic material.

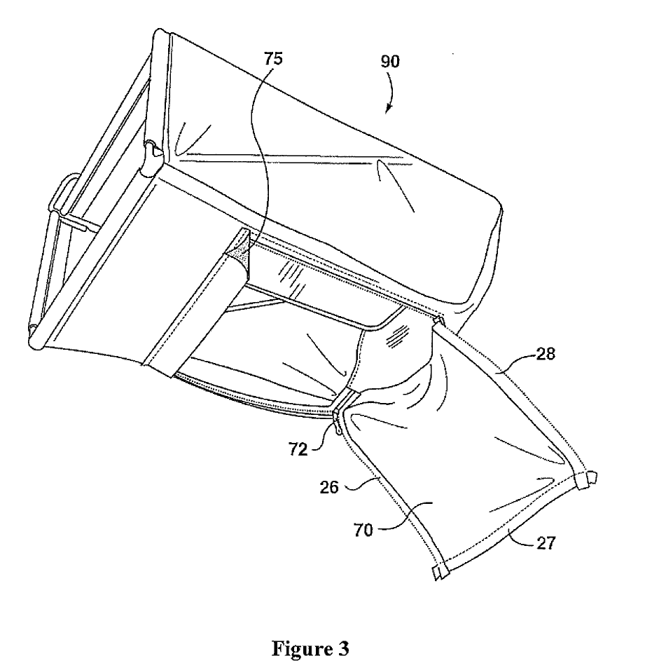

The discharging hole of the grass-collection container of the present invention may be selectively opened or closed. FIG. 2 illustrates the discharging hole 80 in the closed position and FIG. 3 illustrates the discharging hole in the open position. The discharging hole 80 may be selectively opened or closed by fastening means. It may also be possible having the discharging hole partially opened.

Referring to FIGS. 2 and 3, in one embodiment, the bag portion 91 may include a flap or cover 70 for selectively closing the discharging hole 80.

The flap or cover 70 may be adapted to cover the discharging hole 80 when said flap or cover 70 is in a closed position (FIG. 2). The flap or cover 70 may include at least one side 25 which may be continuous with the bag portion (the attached side), and peripheral borders 26, 27 28 which may be releasably attached to the bag portion by fastening means. These releasable borders 26, 26, 28 of the flap 70 may be secured to the bag portion 91 by fastener means 72, 75. In one embodiment, the flap or cover may be an independent cover that may be removably secured to the bag portion by fastener means to cover the discharging means. The strength of the fastener means should be enough to support the bag portion when full of grass clippings.

Some non-limiting examples of fasteners include: full length double zipper construction, a male type hook member and a complementary female type loop member, tying, buttoning, adhesion, and Velcro™ fasteners.

FIGS. 2 and 3 illustrate a rectangular discharging hole 80, which may be closed by a flap or cover 70. It would be obvious to a person of ordinary skill in the art that the discharging hole may take any number of shapes, including polygonal (triangular, square, rectangular, pentagonal) or circular.

Although the figures illustrate one discharging hole and one flap, it would be understood that one or more discharging holes, and one or more flaps may be used.

The flap or cover may be adapted to protect a lawn mower operator from the grass clippings being discharged through the discharging hole while the grass is being cut or mowed by said lawn mower. For example, the flap or cover may be attached to the bag portion adjacent the hole and on the side of the discharging hole which is closest to the rear of the bag portion.

In one embodiment, the present invention provides for a new and inventive configuration for mowing grass, wherein grass clippings may be transported from the chamber of a mower to the bag portion of the grass-collection container of the present invention, from where the grass clippings may be discharged or released back to the ground or turf through the discharging hole during operation of the lawn mower. FIGS. 4 and 5 illustrate the new inventive operational configuration of the present invention. The blades 415 of the lawn mower 100 may cut the grass and the grass clippings 515 thereby produced may then be transported from the chamber of the lawn mower to the bag portion of the grass-collection container 90 through the chute of the lawn mower and the open mounting portion of the grass-collection container. The grass clippings may then be discharged to the ground through the discharging hole 80 while the grass is being cut or mowed by said lawn mower. Arrows labelled A in FIGS. 4 and 5 illustrate the flow of the grass clippings 510 from the chamber 410, to the grass-collection container 90, through the hole 80 and to the ground 520. Arrow B illustrates the cutting direction of the lawn mower while it cuts the grass.

In one embodiment, the grass collection container of the present invention may be used in a new method for mowing grass. The method of mowing grass may comprise: (1) providing a lawn mower capable of being configured to selectively bag grass clippings into the grass-collection container of the present invention; and (2) operating the lawn mower for mowing the grass, wherein the grass clippings may be discharged through the discharging means of the grass-collection container while the grass is being mowed by said lawn mower 100.

As previously stated, in one embodiment, the grass-collection container may be adapted to be removably attached to the chute of the lawn mower. As such, a lawn mower may be used in any of the three known configurations, that is bagging, side discharge and mulching, as well as in the new configuration of the present invention. For example, when provided with a closing flap, the flap may be used (i) in the closed position to set the lawn mower in the bagging configuration or (ii) in the open position to set the lawn mower in the new discharge configuration of the present invention. When the grass-collection container is removed from the lawn mower, the lawn mower 100 may be used in the side discharge or in the mulching configuration.

The grass-collection container of the present invention may be provided as an after-market accessory or sold with the rest of the lawn mower. As an after-market part, the grass-collection container may replace any existing bag assembly of another pre-existing lawn mower, provided the grass-collection container of the present invention attaches to the other lawn mower properly. In this regard, the means for interconnecting the grass-collection container of the present invention to the lawn mower may be modified to retrofit the grass-collection container of the present invention to fit pre-existing lawn mowers. Also, the size of the opening portion may be modified to match the discharge openings of other lawn mowers.

The above disclosure generally describes the present invention. Changes in form and substitution of equivalents are contemplated as circumstances may suggest or render expedient. Although specific terms have been employed herein, such terms are intended in a descriptive sense and not for purposes of limitation. Other variations and modifications of the invention are possible. As such modifications or variations are believed to be within the sphere and scope of the invention as defined by the claims appended hereto.

I claim:

1. A grass-collection container for attachment to a lawn mower, wherein said grass-collection container comprises: (a) an open mounting portion, said open mounting portion configured to interface with a grass clipping discharge chute of the lawn mower, and to allow transport therethrough of the grass clippings discharged by the chute; and (b) a bag portion for receiving the grass clippings, said bag portion including discharging means configured to permit discharge of the grass clippings from the bag portion while the grass is being cut by said lawn mower.

2. The grass-collection container of claim 1 wherein the discharging means comprise one or more discharging holes.

3. The grass-collection container of claim 1 wherein the discharging means is located on a bottom side of the bag portion such that the discharging means is facing the ground when the grass-collection container is attached to said lawn mower.

4. The grass-collection container of claim 1 wherein the discharging means is configured to be selectively opened or closed.

5. The grass-collection container of claim 1 wherein the bag portion includes one or more flaps for selectively closing or opening the discharging means.

6. The grass-collection container of claim 6 wherein said one or more flaps are adapted to protect a lawn mower operator from the grass clippings being discharged through the discharging means while the grass is being cut by said lawn mower.

7. The grass-collection container of claim 1 wherein the grass-collection container is configured to be removably attached to the lawn mower.

8. A lawn mower capable of being configured to selectively bag grass clippings, wherein the lawn mower comprises: (1) a mower base configured to cut grass, said mower base having a grass clippings discharge chute through which grass clippings can exit the mower base; and (2) a grass-collection container attached to said base, said grass-collection container comprising: (a) an open mounting portion, said open mounting portion configured to interface with the grass clippings discharge chute and to allow transport therethrough of the grass clippings discharged by the chute; and (b) a bag portion for receiving the grass clippings, wherein said bag portion includes discharging means configured to permit discharge of the grass clippings from the bag portion while the grass is being mowed by said lawn mower.

9. The lawn mower of claim 8 wherein the discharging means comprises one or more discharging holes.

10. The lawn mower of claim 8 wherein the discharging means is located on a bottom side of the bag portion such that the discharging means is facing the ground when the grass-collection container is attached to said lawn mower.

11. The lawn mower of claim 8 wherein the discharging means is configured to be selectively opened or closed.

12. The lawn mower of claim 8 wherein the bag portion includes one or more flaps for selectively closing or opening the discharging means.

13. The lawn mower of claim 12 wherein said one or more flaps are adapted to protect a lawn mower operator from the grass clippings being discharged through the discharging means while the grass is being cut by said lawn mower.

14. The lawn mower of claim 8 wherein the grass-collection container is configured to be removably attached to the lawn mower.

15. A method of mowing grass, wherein said method comprises: (1) providing a lawn mower capable of being configured to selectively bag grass clippings into a grass-collection container, the grass-collection container comprising: (a) an open mounting portion configured to interface with a grass clippings discharge chute of the mower and to allow transport therethrough of the grass clippings discharged by the chute; and (b) a bag portion for receiving the grass clippings cut by said lawn mower, said bag portion including discharging means configured to permit discharge of the grass clippings from the bag portion while the grass in being cut; and (2) operating the lawn mower for cutting the grass, thereby discharging the grass clippings through the discharging means while the grass is being cut by said lawn mower.

16. The method of claim 15 wherein the discharging means comprises one or more discharging holes located on a bottom side of the bag portion such that the discharging means is facing the ground when the grass-collection container is attached to said lawn mower.

17. The method of claim 15 wherein the discharging means is configured to be selectively opened or closed.

18. The method of claim 15 wherein the bag portion includes one or more flaps capable of selectively closing or opening the discharging means.

19. The method of claim 15 wherein said one or more flap means are adapted to protect a lawn mower operator from the grass clippings being discharged through the discharging means while the grass is being cut by said lawn mower.

20. The method of claim 15 wherein the grass-collection container is configured to be removably attached to the lawn mower.
